(19) United States
(12) Patent Application Publication
(10) Pub. No.: US 2008/0092428 A1
(43) Pub. Date: Apr. 24, 2008

(54) Owl, simulated animal and bird decoy

(76) Inventor: George W. Brint, Bolivar, TN (US)

Correspondence Address: John M. Harrison, 2139 E. Bert Kouns, Shreveport, LA, 71105, US

(21) Appl. No.: 11/900,460

(22) Filed: Sep. 12, 2007

Related U.S. Application Data
(60) Provisional application No. 60/852,169, filed on Oct. 18, 2006.

(51) Int. Cl. A01M 31/06

(52) U.S. Cl. 43/2

(57) ABSTRACT

An owl, simulated animal and bird decoy for attracting wildlife, and particularly predators, crows and other predatory animals and birds, which decoy is characterized in a first embodiment by a simulated owl adapted for mounting on a stake, post or support inserted in the ground or on a tree limb, with a mechanical bird extending downwardly from the owl's talons. The mechanical bird is typically provided with movable, folding wings mounted on hinged wing mounts to facilitate extending one or both of the wings outwardly, and in folded configuration inwardly of the body, wherein the wings flap and/or vibrate by means of a battery-operated electric motor in the extended and/or folded configuration to simulate distress. In another embodiment the mechanical bird may be attached to or suspended from a tree limb with one or both of the wings extended or folded to simulate distress in the decoy. In still another embodiment a simulated animal is fitted with a battery-operated, eccentric vibrating device and is suspended from an owl or a fixed object such as a tree limb.

### CROSS-REFERENCE TO RELATED APPLICATIONS

This application claims the benefit of and incorporates by reference in its entirety prior filed copending U.S. Provisional Application Ser. No. 60/852,169, filed Oct. 18, 2006.

### SUMMARY OF THE INVENTION

An owl, simulated animal and bird decoy for attracting wildlife and particularly, predatory animals and birds, as well as foraging or waterfowl birds, including crows. The decoy is characterized by a simulated owl adapted for mounting on an upright pole, stake or other support extended into the ground or mounted on a stand in one embodiment, with a mechanical bird or simulated animal extending from or engaging the owl's talons to simulate capture of the bird or animal by the owl. In another embodiment the owl is positioned on a tree limb with the mechanical bird or animal extending from or engaging the owl's talon, for the same purpose. The mechanical bird is typically fitted with hinged wing mounts to facilitate extension and retraction or folding of one or both of the wings against the bird body and is provided with a switch and an internal electric motor and battery to facilitate flapping of the extended wings and vibration of the folded wings, to simulate distress. The simulated animal is typically fitted internally with an eccentric vibrating device which causes the animal to move and shake. In yet another embodiment of the invention the bird or animal may be suspended without the owl decoy from a limb of a tree with the bird wings folded or extended or one wing extended and the other folded, to simulate distress in the decoys.

### BRIEF DESCRIPTION OF THE DRAWINGS

The invention will be better understood by reference to the accompanying drawings, wherein:

FIG. 1 is a perspective view of an owl and bird decoy embodiment of this invention, with the simulated owl decoy mounted on an upright support and a mechanical bird decoy extending downwardly from the owl talons and having both mechanical bird decoy wings extended;

FIG. 2 is a perspective view of the owl and bird decoy, with the owl decoy mounted on the limb of a tree and the mechanical bird decoy extending downwardly from the talons of the owl decoy, with both mechanical bird decoy wings extended;

FIG. 3 is a perspective view of the owl and bird decoy illustrated in FIG. 1, with the owl decoy mounted on a support and the mechanical bird decoy extended downwardly from the owl talons, with one of the mechanical bird decoy wings extended and the other folded;

FIG. 4 is a perspective view of the owl and bird decoy illustrated in FIG. 2, with the owl decoy placed on a limb and the mechanical bird decoy extending downwardly from the owl's talons, with one mechanical bird decoy wing extended and the other folded;

FIG. 5 is a perspective view of the owl and bird decoy illustrated in FIG. 3, more particularly illustrating the owl decoy mounted in an upright support, with the mechanical bird decoy extending downwardly from the owl's talons and both of the mechanical bird decoy wings folded;

FIG. 6 is a perspective view of the owl decoy and mechanical bird decoy of this invention, with the owl decoy perched on a limb and the mechanical bird decoy extending downwardly from the owl's talons, with both of the mechanical bird decoy wings folded;

FIG. 7 is a perspective view of a mechanical bird decoy without the owl decoy, suspended from the limb of a tree with both wings extended;

FIG. 8 is a perspective view of the mechanical bird decoy illustrated in FIG. 7, with one wing extended and one wing folded;

FIG. 9 is a perspective view of the mechanical bird decoy illustrated in FIGS. 7 and 8 with both wings folded;

FIG. 10 is a perspective view of an owl and simulated animal decoy of this invention with the owl decoy mounted on an upright support and a simulated animal internally fitted with a vibrating device, extending downwardly from the owl talons;

FIG. 11 is a perspective view of the owl and simulated animal decoy, with the owl decoy mounted on a limb of a tree and the simulated animal extending downwardly from a talon of the owl decoy;

FIG. 12 is a perspective view, partially in section of a typical talon configuration of the owl decoy of this invention;

FIG. 13 is a perspective view of a typical eccentric vibrating mechanism or device for inducing vibration in the simulated animal decoy illustrated in FIGS. 10, 11 and 14-16;

FIG. 14 is a front view of a simulated animal decoy with an internal eccentric vibrating device illustrated in phantom and suspended by an S-hook from a talon of the owl decoy;

FIG. 15 is a front view of the simulated animal decoy illustrated in FIG. 14 suspended by a monofilament loop from the talon of the owl decoy;

FIG. 16 is a front view of the simulated animal decoy illustrated in FIG. 15, suspended by wire from a talon of the owl decoy;

FIG. 17 is a perspective view of the simulated animal decoy illustrated in FIG. 16 with the eccentric vibrating device inserted therein and illustrated in phantom and with the simulated animal and eccentric device suspended from a limb of a tree, typically using a monofilament loop; and

FIG. 18 is a front view of the simulated animal decoy illustrated in FIG. 17 with the eccentric vibrating device inserted therein and illustrated in phantom and with the simulated animal and eccentric device suspended from a limb of a tree, using an S-hook.

### DESCRIPTION OF THE PREFERRED EMBODIMENTS

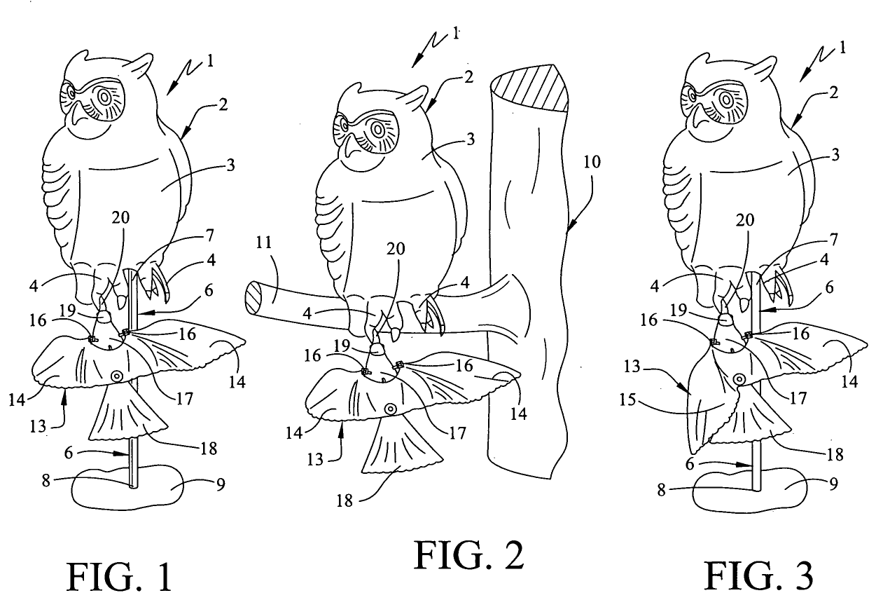

Referring initially to FIG. 1 of the drawings, the owl and bird decoy embodiment of this invention is generally illustrated by reference numeral 1. The owl and bird decoy 1 is characterized by a simulated owl 2, having a owl body 3 and owl talons 4, as illustrated. The owl body 3 is mounted on the top support end 7 of a top support 6 at the owl talons 4, while the bottom support end 8 of the support 5 is either extended into the ground 9 as illustrated or mounted on a stand or brace (not illustrated). A mechanical bird 13 is disposed beneath the owl 2 and is attached or connected to one of the owl talons 4, typically at the head 19 or beak 20 of the mechanical bird 13, using a tether, tie or fastener (not illustrated) such as a length of monofilament fishing line. The head 19 of the mechanical bird 13 is attached to the bird body 17 as illustrated and simulated bird tail feathers 18 extend from the bird body 17, while the extended wings 14 are mounted on the bird body 17 by means of hinged wing mounts 16, as further illustrated in FIG. 1. The mechanical bird 13 is also provided with a direct current electric motor, batteries and a switch (not illustrated) in conventional fashion, to facilitate selective flapping of the extended wings 14 and simulate distress in the mechanical bird 13 and capture by the owl 2 in the owl and bird decoy 1.

As illustrated in FIG. 2 of the drawings, the owl body 3 of the owl 2 is seated or perched on the limb 11 of a tree 10 in any convenient fashion, such that the mechanical bird 13 extends downwardly from one of the owl talons 4, to which the head 19 or beak 20 of the mechanical bird 13 are typically attached or connected in any convenient manner, such as a screw, bolt or monofilament fishing line, in non-exclusive particular. The mechanical bird 13 is configured such that the extended wings 14 are oriented for flapping in the same manner as the extended wings 14 illustrated in FIG. 1, to indicate distress in the mechanical bird 13.

Referring now to FIG. 3 of the drawings, the owl body 3 of the owl 2 is mounted on the top support end 7 of a support 6 and the mechanical bird 13 extends downwardly, typically from attachment to either the head 19 or beak 20, to one of the owl talons 4, using a suitable connector, tie or tether, as hereinafter described. In this configuration the mechanical bird 13 is characterized by an extended wing 14 and a folded wing 15, the latter of which vibrates while the extended wing 14 flaps, to accentuate simulated distress in the mechanical bird 13.

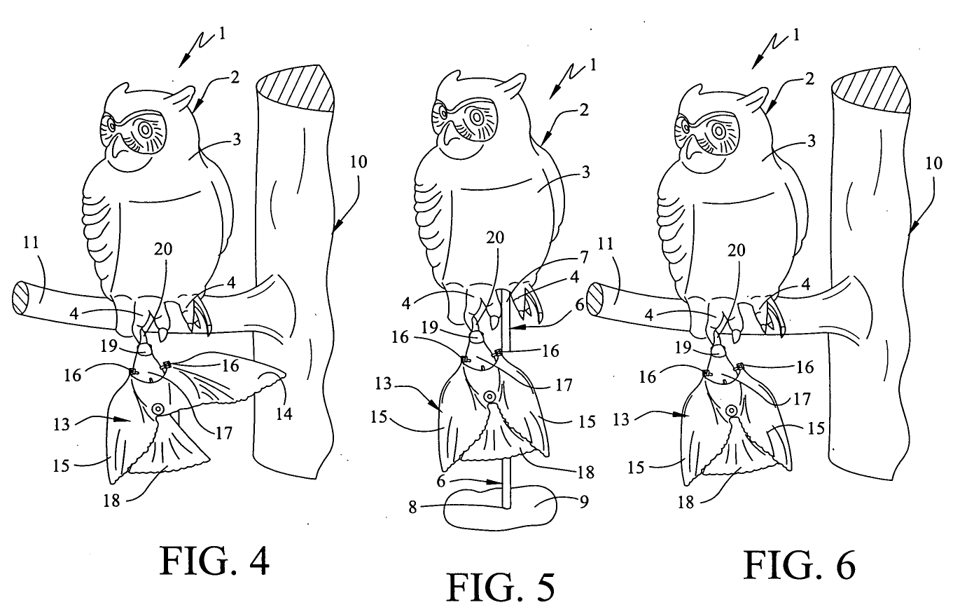

Referring to FIG. 4 of the drawings, the owl body 3 of the owl 2 is mounted on a limb 11 of a tree 10, with the mechanical bird 13 attached by means of a connector, such as a tie or tether to the head 19 or beak 20 and one of the owl talons 4, as hereinafter described. In this configuration of the mechanical bird 13, the extended wing 14 is allowed to flap while the folded wing 15 vibrates, to indicate accentuated distress in the mechanical bird 13 for the attraction of predators to the owl and bird decoy 1.

As illustrated in FIG. 5 of the drawings, the owl body 3 of the owl 2 is mounted on the top support end 7 of a support 6, while the bottom supporting 8 is extended into the ground 9. When the mechanical bird 13 is positioned below the owl body 3 and is connected to an owl talon 4, typically at the head 19 or beak 20 with both of the folded wings 15 in folded and vibrating configuration, the mechanical bird 13 is positioned to attract predators, as illustrated.

Referring to FIG. 6 of the drawings, the owl body 3 of the owl 2 is mounted on a limb 11 of a tree 10 and the mechanical bird 13 is configured with both folded wings 15 in vibrating configuration as illustrated in FIG. 5. Further, as illustrated in FIG. 5, the mechanical bird 13 is typically suspended from one of the owl talons 4 at the head 19 or the beak 20 by a suitable connector, such as a tie or tether, typically in the manner hereinafter described.

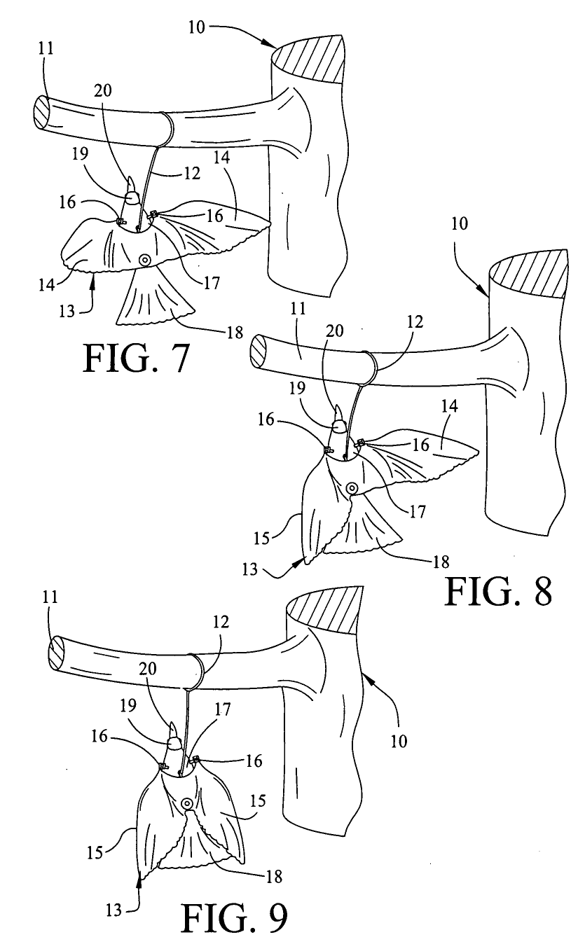

Referring now to FIG. 7 of the drawings, in another embodiment of the invention a mechanical bird 13 is attached or tethered directly to the limb 11 of a tree 10, typically using nearly invisible monofilament fishing line 12 of selected size and length, in non-exclusive particular, with the extended wings 14 projecting outwardly of the bird body 17 at the hinged wing mounts 16. This orientation of the mechanical bird 13 facilitates flapping of the extended wings 14 by operation of the internal electric motor and battery (not illustrated), to simulate distress of the mechanical bird 13 suspended in the tree 10.

As illustrated in FIG. 8 of the drawings, a mechanical bird 13 is attached to the limb 11 of the tree 10 using a suitable tie, tether or other connector such as the monofilament fishing line 12 as illustrated in FIG. 7, with an extended wing 14 configured to flap, while the folded wing 15 is configured to vibrate and further indicate distress in the mechanical bird 13 to attract predators.

As further illustrated in FIG. 9 of the drawings, the mechanical bird 13 is likewise suspended from the limb 11 of a tree 10 and is configured with both folded wings 15 in vibrating, accentuated distress configuration, to attract predators.

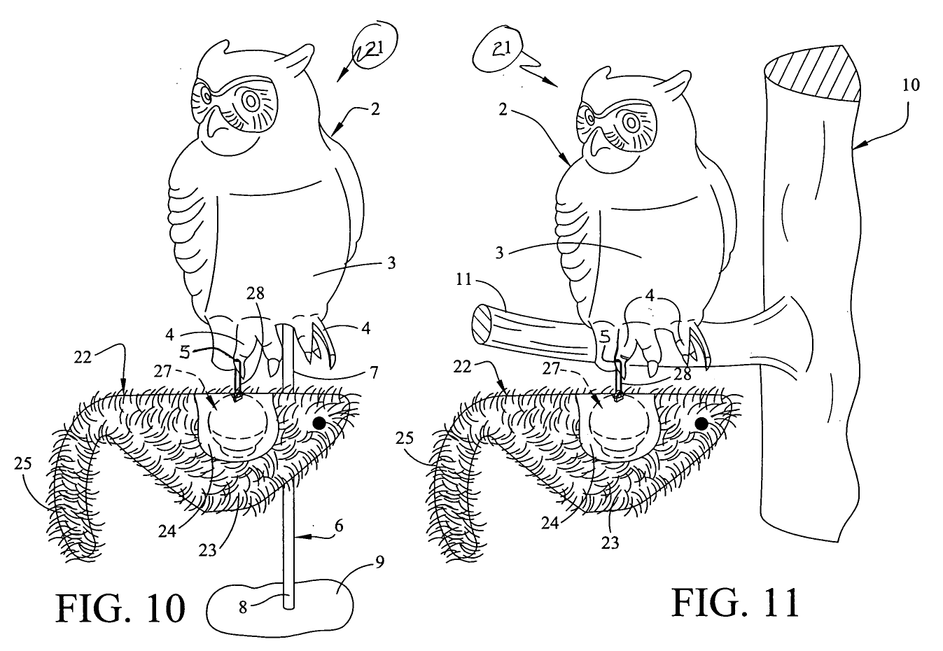

Referring now to FIG. 10 of the drawings, in another embodiment of the invention the owl decoy 2 of an owl and simulated animal decoy 21 is fitted to the support 6 at a top support end 7 and the bottom support end 8 of these support 6 is typically extended into ground 9, as illustrated. A simulated animal 22 is configured to generally represent a fox, rabbit, squirrel, chipmunk, rat or the like, which is typically the prey of an owl, and suspended from one of the owl talons 4 of the owl 2, typically using a connector or tether 28. The connector or tether 28 may be wire, cord, or a length or loop of monofilament line of selected diameter and length, the latter of which is essentially invisible, in non-exclusive particular. The tether 28 is typically extended through a talon opening 5 in the owl talon 4 and connected to a vibrating ball 27, at an eyelet 27a. The simulated animal 22 is caused to vibrate, thus shaking the animal body 23 and the animal tail 25 responsive to operation of the internally-positioned vibrating ball 27. In a typical embodiment the vibrating ball 27 is tightly inserted in a body cavity 24 shaped in the animal body 23 of the simulated animal 22. Referring to FIG. 13 of the drawings, the vibrating ball 27 is illustrated with the eyelet 27a for attachment of the connector or tether 28 to one of the owl talons 4 of the owl 2. The vibrating ball 27 is typically conventional in design and is configured with an internally positioned eccentric (not illustrated) and a battery pack (also not illustrated), as well as a switch (also not illustrated) for actuating the eccentric and causing the ball to vibrate, which also causes the animal body 23 and the animal tail 25 to vibrate or shake and simulate the movements of prey captured by the owl 2.

As illustrated in FIG. 11, the owl and simulated animal decoy 21 may be designed such that the vibrating ball 27 is located in the body cavity 24 of the animal body 23 of the simulated animal 22 and the simulated animal 22 and vibrating ball 27 then suspended from an owl 2 which is seated on a limb 11 of a tree 10, typically in the same manner as the suspension and connection illustrated in FIG. 10 of the drawings. Operation of the vibrating ball 27 thus causes the animal body 23 to vibrate along with the animal tail 25, to attract predators.

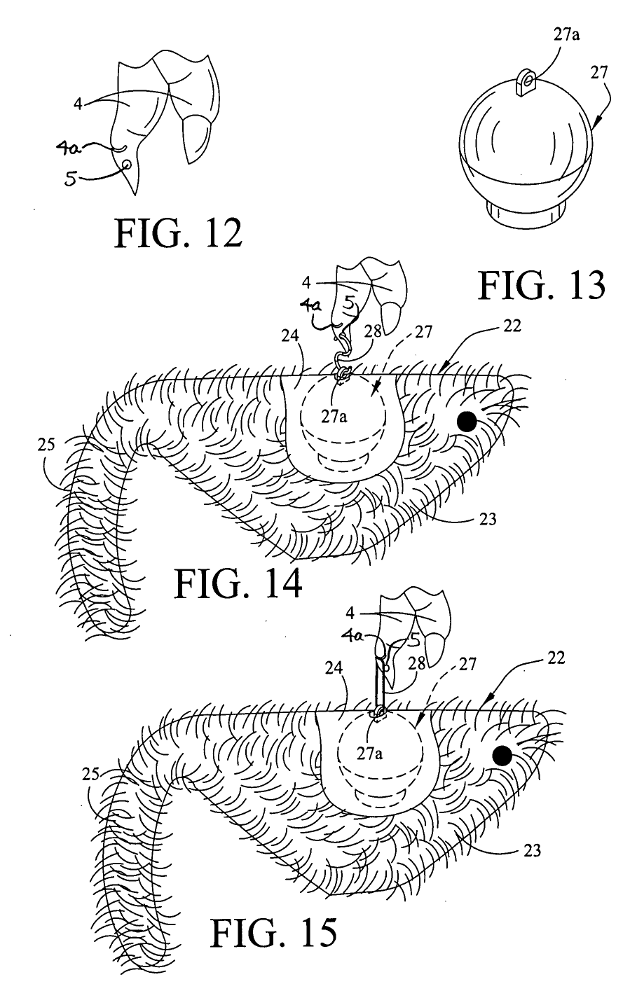

Referring to FIG. 12 of the drawings, a typical owl talon 4 configuration is illustrated, wherein a talon slot 4a and talon hole or opening 5 may be provided in one or more of the owl talons 4 for extending the connector or tether 28 therethrough or receiving a screw or bolt fastener (not illustrated) therein, as desired, and connecting the respective decoys to the owl talons 4.

As illustrated in FIGS. 13 and 14 of the drawings, it will be appreciated that the vibrating ball 27 and simulated animal 22 can be suspended from the owl talon 4 using a connector or tether 28 which is shaped in the configuration of an S-hook. One end of the S-hook is typically extended through a talon opening 5, while the opposite end is extended through the eyelet 27a on the vibrating ball 27.

As illustrated in FIG. 15, suspension of the simulated animal 22 from the owl 2 can be effected using the flexible connector or tether 28, consisting of a monofilament fishing line loop, which is typically inserted in the talon slot 4a of the owl talon 4, and extended through the eyelet 27a, as illustrated.

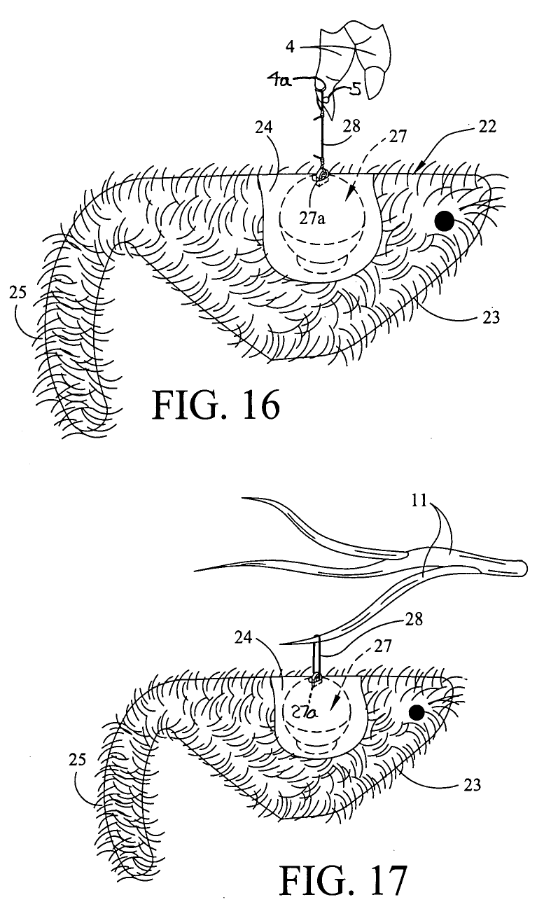

As illustrated in FIG. 16, the simulated animal 22 can be suspended from the owl talons 4 typically using a piece of wire as the connector or tether 28, one end of which wire may be extended through the talon slot 4a or the talon opening 5 located in the owl talon and the other end of which is attached to the eyelet 27a of the vibrating ball 27.

Referring now to FIG. 17 of the drawings, it will be appreciated that the simulated animal 22 with the internally-located vibrating ball 27 can be suspended directly from a tree limb 11, typically using a connector or tether 28 which is shaped in the configuration of a loop and is constructed of monofilament line or the like.

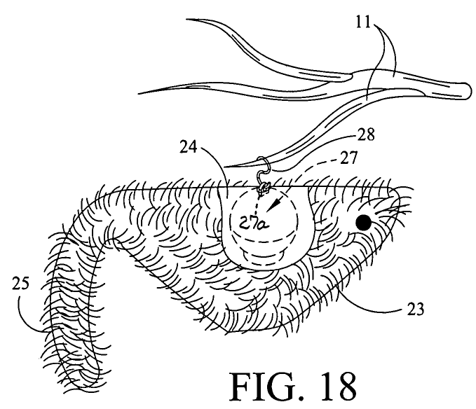

FIG. 18 illustrates mounting of the simulated animal 22 and the enclosed or internal vibrating ball 27 on a tree limb 11 using an S-hook extending through the eyelet 27a and around the tree limb 11.

It will be appreciated from a consideration of the drawings that the owl decoy 2 and both the mechanical bird 13 and the simulated animal 22, in various combinations, can be configured such that the owl 2 is mounted on a support 6 of any desired design and height, as well as on the limb 11 of a bush or tree 10. Furthermore, the mechanical bird 13 and simulated animal 22 can be suspended from the owl talons 4 in any convenient fashion, typically by means of screws, bolts, wire, string, S-hooks, monofilament fishing line or the like, and typically from the head 19 or the beak 20, in the case of the mechanical bird 13, such that the flapping of the extended wings 14 and vibration of the respective folded wing(s) 15, respectively, simulate an agitation or distress of the mechanical bird 13 in the owl talons 4. This simulated distress of the mechanical bird 13 and vibrating simulated animal 22 is effective to attract predators such as coyotes, bobcats, wolves and the like, in non-exclusive particular, as well as birds such as crows and the like, to the various decoys for hunting purposes.

It will be further appreciated by those skilled in the art that as illustrated in FIGS. 7-9, the mechanical bird 13 can be suspended from a limb 11 of a bush or tree 10 by itself, with the respective extended wings 14 and folded wings 15, respectively, likewise flapping and vibrating, for the same purpose. In like manner, the mechanical bird 13 can be tied or tethered directly to a limb 11, rather than suspended, as desired. Furthermore, it will be appreciated that the mechanical bird 13 can be constructed and painted to simulate various types of birds, including crows and waterfowl, such as ducks, geese and the like, to vary the decoy characteristics, depending upon the nature and kind of wildlife to be attracted. In like manner, the simulated animal 22 can be designed in shape and color patterns to simulate any prey of the owl, including a mouse, rat, squirrel, chipmunk, fox or the like. It will also be appreciated that the owl decoy 2 can be replaced by other predatory birds such as hawks, eagles and the like, in non-exclusive particular.

While the preferred embodiments of the invention on have been described above, it will be recognized and understood that various modifications may be made in the invention and the appended claims are intended to cover all such modifications which may fall within the spirit and scope of the invention.

Having described my invention with the particularity set forth above, what is claimed is:

1. A decoy comprising a mechanical bird decoy having folding, self-operated, moving wings, said mechanical bird decoy secured to a tree for attracting wildlife and birds to the decoy responsive to movement of said wings.

2. The decoy of claim 1 comprising a connector attached to said mechanical bird decoy and the tree, wherein said mechanical bird decoy is suspended from the tree.

3. The decoy of claim 1 wherein at least one of said wings of said mechanical bird decoy is disposed in folded configuration.

4. The bird of claim 3 comprising a connector attached to said mechanical bird decoy and the tree, wherein said mechanical bird decoy is suspended from the tree.

5. A decoy comprising a predatory bird decoy disposed on a support and a mechanical bird decoy attached to said predatory bird decoy, said mechanical bird decoy having self-operated, moving wings for attracting predators and birds.

6. The decoy of claim 5 comprising at least one talon provided on said predatory bird decoy and a connector connecting said mechanical bird decoy to said talon of said predatory bird decoy.

7. The decoy of claim 6 wherein at least one wing of said mechanical bird decoy is disposed in folded configuration.

8. The decoy of claim 6 comprising a connector connecting said mechanical bird decoy to said talon of said predatory bird decoy and wherein at least one of said wings of said mechanical bird decoy is disposed in folded configuration.

9. The decoy of claim 5 wherein said support comprises a stake or rod of selected size extending from a supporting surface to support said predatory bird decoy.

10. The decoy of claim 9 comprising a connector connecting said mechanical bird decoy to said talon of said predatory bird decoy and wherein at least one of said wings of said mechanical bird decoy is disposed in folded configuration.

11. The decoy of claim 5 wherein said support is a tree limb.

12. The decoy of claim 11 comprising a connector connecting said mechanical bird decoy to said talon of said predatory bird decoy and wherein at least one wing of said mechanical bird decoy is disposed in folded configuration.

13. The decoy of claim 6 comprising at least one slot or opening provided in said talon for receiving said connector.

14. The decoy of claim 13 wherein at least one wing of said mechanical bird decoy is disposed in folded configuration.

15. A decoy comprising an owl decoy deployed on a support and a simulated animal decoy attached to said owl decoy, said simulated animal decoy having a vibrating mechanism for vibrating said simulated animal decoy and attracting wildlife and birds to the decoy.

16. The decoy of claim 15 comprising a connector connecting said simulated animal decoy to said owl decoy.

17. The decoy of claim 15 comprising at least one talon provided on said owl decoy and a connector connecting said simulated animal decoy to said talon of said owl decoy.

18. The decoy of claim 17 comprising at least one slot or opening provided in said talon for receiving said connector.

19. The decoy of claim 18 wherein said connector comprises a monofilament tie.

20. The decoy of claim 18 wherein said support is a tree or bush.
